(19) United States
(12) Patent Application Publication
(10) Pub. No.: US 2007/0198110 A1
(43) Pub. Date: Aug. 23, 2007

(54) Household Electric Appliance, Appliance Controller, and Appliance Control System

(76) Inventors: Hideaki Suzuki, Hitachi (JP); Makato Kitano, Tsuchiura (JP); Hisao Suka, Tokyo (JP); Hiroaki Matsushima, Ryugasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/624,806

(22) Filed: Jan. 19, 2007

(30) Foreign Application Priority Data
Feb. 20, 2006 (JP) 2006-043222

(51) Int. Cl. G06F 17/00

(52) U.S. Cl. 700/90

(57) ABSTRACT

In an appliance controller 100 for controlling a household electric appliance, a unit information holding part 131 holds unit information identifies a household electric appliance 10, and an operation restriction information holding part 133 can hold operation restriction information indicates operation restrictions to be imposed on the household electric appliance 10. A receiving part 120 receives a forcible control signal transmitted by wireless and demodulates unit information and operation restriction information. A decision part 132 causes the operation restriction information holding part 133 to hold the received operation restriction information when the unit information held in the operation restriction information holding part 133 matches the received unit information. An appliance control part 210 (control computer) controls the operation of the household electric appliance 10 according to the operation restriction information held in the operation restriction information holding part 133.

### CLAIM OF PRIORITY

The present application claims priority from Japanese application serial No. 2006-043222, filed on Feb. 20, 2006, the contents of which is hereby incorporated by reference into this application.

### BACKGROUND OF THE INVENTION

1. Field of the Invention

The present invention relates to a household electric appliance for which the user of a particular product can be externally promoted with ease to receive after-sales service, an appliance controller incorporated into the household electric appliance for this promotion, and an appliance control system including the household electric appliance.

2. Prior Art

Automobiles and other products registration and inspection of which are mandatory by law as well as products provided for industrial purposes and requiring maintenance are periodically inspected and serviced while they are used, so the products are managed according to the laws and uniformalized standards stipulated by the manufacturers. Since these types of products are periodically inspected and serviced as described above, the manufacturers and the third parties can check the usage states and locations of the products.

Once a household electric appliance oriented to ordinary homes is shipped from the manufacturer and delivered to a user, its use and management are left to the user; the manufacturer and the like rarely participate. Therefore, it is very difficult for the manufacture to exhaustively check the use and locations of shipped household electric appliances.

Besides the country or area where the product was manufactured, the product may be used in an importing country or area. Since the climate, culture, and other conditions vary with the importing country or area, how the product is used in what environment is also vary. In some countries or areas, the inspection and management of household electric appliances may become difficult due to social or political factors.

Household electric appliances and other industrial products are usually worn as they are used. As described above, household electric appliances are managed by users; the length of a period during which the product is used is determined at the discretion of the user. As a result, the product may be used continuously for a period far longer than a service life assumed by a third party in a neutral position. The service life should be set in consideration of social agreement and scientific and technological findings, and specialized knowledge is required for inspection and repair. In spite of these requirements, a collected product that has been neither inspected nor repaired correctly, for example, may be sold as having been inspected and an ordinary user who believes the indication may buy and use the product.

Reliability of household electric appliances has been improved by assuming many situations, but it is preferable to further improve the reliability.

The following technologies are described for reference only although they largely differ from the present application even from the viewpoint of the objects and problems.

First, a stolen vehicle search system is proposed in, for example, Patent Document 1 in which when a command to search a stolen vehicle is input into a center apparatus, the center apparatus sends the search command to a vehicle-mounted unit by wireless; upon receipt of the command signal, the vehicle-mounted unit generates a control signal for stopping the engine and sends a vehicle position obtained by the vehicle information and communication system (VICS) by wireless.

Another apparatus proposed in, for example, Patent Document 2, is a wireless mobile telephone that has a sensor for receiving a power-off command signal; when the sensor receives a power-off command signal from a power-off command signal generator installed in advance in a use restricted area, the power supply of the radio part is turned off to disable the mobile phone from being used (the mobile phone is placed in a situation equivalent to being placed outside a communication range).

[Patent Document 1] Japanese Patent Application Laid-open Publication No. 11-321566 (paragraph 0014, FIG. 2)

[Patent Document 2] Japanese Patent Application Laid-open Publication No. 2002-186021 (paragraphs 0014 and 0019, FIG. 2)

### SUMMARY OF THE INVENTION

For many household electric appliances manufactured and shipped, inspection and maintenance are preferably encouraged in a rational manner. For many household electric appliances that are highly likely to have been used for a period far longer than their service lives or household electric appliances having special factors, for example, action is preferably taken in a rational manner.

The above stolen vehicle search system (described in Patent Document 1) is addressed to automobiles; periodic inspection of automobiles is mandatory by low, so non-inspected automobiles are usually prohibited from running on roads by law. Accordingly, automobiles are products that have nature completely different from that of household electric appliances, management of which is left to individual users, so the technology described in Patent Document 1 cannot be applied to home-use products. In addition, with the technology in Patent Document 1, it is required that a positional information signal be transmitted from the vehicle-mounted unit to the center apparatus. The center apparatus and vehicle-mounted unit must be therefore capable of bi-directionally communicating in a target area, preventing the target vehicle to be located with ease. Another problem is that rational action cannot be taken for many products (automobiles).

The above wireless mobile telephone (described in Patent Document 2) is targeted at wireless mobile telephone control, but all wireless mobile telephones that can make a call or communicate are always managed by a carrier, and the areas in which they are used are grasped. Accordingly, wireless mobile telephones can be said to be products that have nature completely different from that of household electric appliances management of which is left to individual users, so the technology described in Patent Document 2 cannot be applied to home-use products. In addition, the technology in Patent Document 2 unconditionally turns off the power supplies of the wireless parts of all wireless mobile telephones in a particular area, and cannot stop the operation of a particular wireless mobile telephone. When, for example, the wireless mobile telephone with the wireless part turned off is moved out of the range in which the power-off signal is received, the wireless part can be turned on again, enabling the wireless mobile telephone to be used as usual. This prevents the user from being promoted to take action. In addition, the power supply of the wireless part can be forcibly turned off only when the wireless mobile telephone is present in a reception range. Therefore, the technology cannot be applied to household electric appliances fixed in homes or other places.

The present invention addresses the above problems with the object of providing a household electric appliance for which the user of a particular product can be externally promoted with ease to receive after-sales service, an appliance controller, and an appliance control system.

With the household electric appliance, appliance controller, and appliance control system according to the present invention, a signal having unit information under a particular condition is received and then demodulated. When the unit information held in the household electric appliance matches the demodulated unit information, the operation or part of the functions of the household electric appliance is stopped, that is, the operation of the household electric appliance is restricted. The technological concept of specific means will be represented by describing embodiments of the present invention in detail.

The inventive household electric appliance, appliance controller, and appliance control system according to the present invention enable the user of a particular product to be externally promoted with ease to receive after-sales service.

### BRIEF DESCRIPTION OF THE DRAWINGS

FIG. 1 is a conceptual view of an appliance control system according to an embodiment of the present invention.

FIG. 2 is a block diagram indicating the household electric appliance according to an embodiment of the present invention.

FIG. 3 is a block diagram indicating a household electric appliance according to another embodiment of the present invention.

FIG. 4 is a flowchart indicating a first example of operation restriction information update processing in the embodiment of the present invention.

FIG. 5 is a flowchart indicating a second example of operation restriction information update processing in the embodiment of the present invention.

FIG. 6 is a flowchart indicating operation restriction processing in the embodiment of the present invention.

FIG. 7 is a longitudinal cross section of a washer dryer to show one type of the household electric appliance.

FIG. 8 is a longitudinal cross section of a refrigerator to show one type of the household electric appliance.

FIG. 9 is an external perspective view of an air-conditioner to show one type of the household electric appliance.

### DETAILED DESCRIPTION OF THE INVENTION

Embodiments of the present invention will be described below with reference to the attached drawings.

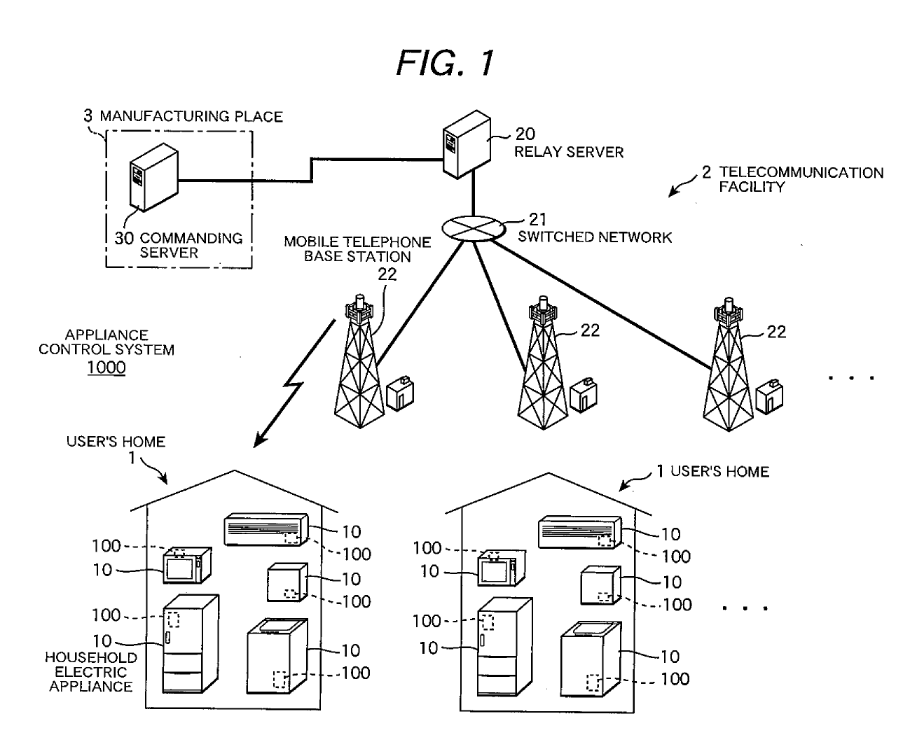

FIG. 1 is a conceptual view of an appliance control system 1000 according to an embodiment of the present invention.

The appliance control system 1000 comprises household electric appliances 10 used by the user inside and outside a user's home 1, a telecommunication facility 2 operated by a carrier, and a commanding server 30 that is managed by the manufacturer of the household electric appliances 10 and installed in a manufacturing place 3.

The commanding server 30 is a computer that identifies desired ones from the household electric appliances 10 and sends the telecommunication facility 2 a command according to which messages are sent to the household electric appliances 10. The commanding server 30 holds a unit ledger, which will be described later in detail, the unit ledger including information about the household electric appliances 10 shipped from the manufacturing place 3.

The telecommunication facility 2 serves in telecommunication business through which wireless mobile telephones (not shown) communicate. The telecommunication facility 2 has many mobile telephone base stations 22, which are wireless stations performing wireless communication with wireless mobile telephones in predetermined areas, a switched network 21 through which communication is performed with wireless mobile telephones via the accommodated mobile telephone base stations 22, and a relay server 20 connected to the switched network 21.

The telecommunication facility 2 has a function that can unilaterally send an arbitrary message from a mobile telephone base stations 22 to a particular wireless mobile telephone with which to communicate even if there is no response from the mobile telephone. As this type of messages, messages that are sent in various forms can be used; for example, a message is sent as a packet payload of message data, part of a packet header, or part of control data that differs from a data packet. This type of message can be sent, for example, with a particular identifier specified or without an identifier. This function can be implemented by modifying the control software in the mobile telephone base stations 22 and switched network 21 or adding control software intended for message transmission control.

The telecommunication facility 2 is a cellular system in which communication is controlled for each communication region (cell) associated with a mobile telephone base station 22. Accordingly, since the relay server 20 controls the mobile telephone base stations 22 in the telecommunication facility 2, whether to send a message can be determined for each communication region (cell). Of course, the relay server 20 can perform control so that messages are sent from all mobile telephone base stations 22.

Alternatively, a facility at a broadcast station that performs broadcasting by wireless can be used instead of the telecommunication facility 2. The broadcast station may be intended for acoustic broadcasting, image broadcasting, or data broadcasting if the broadcast station can send data in any form.

When a transmission facility for teletext is used or radio broadcasting (acoustic broadcasting) is performed, spacing between frequencies assigned to acoustic broadcasting or the high-frequency range of a sub-carrier used in stereo broadcasting is utilized for message data transmission. In television broadcasting in which signals resulting from analog modulation are used, areas equivalent to scanning lines in a blank space left between a vertical synchronous range and an effective video range is used to superimpose message data.

A television broadcast station that uses digital signals may also be used. When, for example, a television station based on the conditional access system (CAS), the ID of a CAS card can be specified for message data transmission instead of reception-restricted data specified for each ID.

In a broadband digital broadcasting system in which a single channel can be divided into segments, such as the integrated services digital broadcasting (ISDB) system, a system in which the single segment (called the one-segment broadcasting) is employed is preferably used. The one-segment broadcasting is advantageous in that the structure of an appliance controller 100 (described later) can be simplified because the data processing load is small and a particular decryption key is not required at present. When the length of the message described above (the amount of data) is considered, an overmuch transfer band is assigned.

The commanding server 30 and relay server 20 are interconnected with a communication line. The communication line is preferably a dedicated line or a highly safe line such as a private virtual network (PVN) to prevent unexpected intervention by a third party (a party other than the carrier and manufacturer). This is also true for the communication line for interconnecting the relay server 20 and switched network 21.

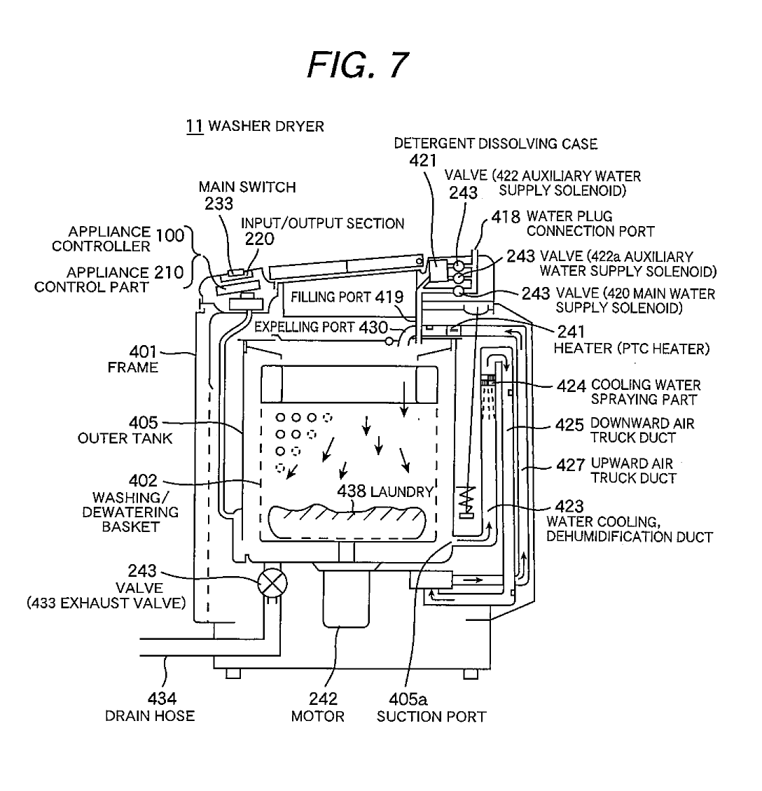

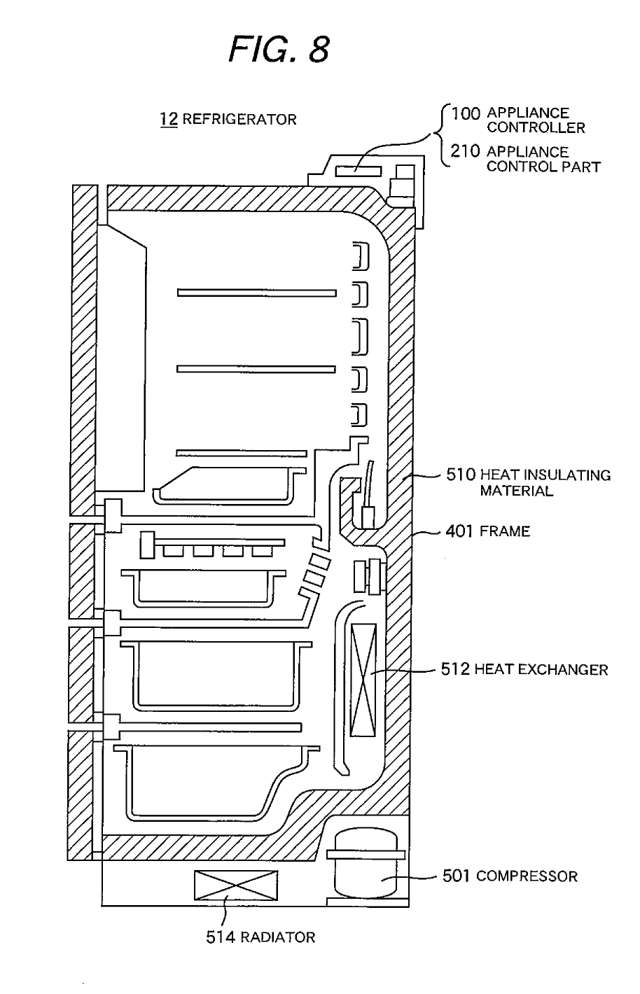

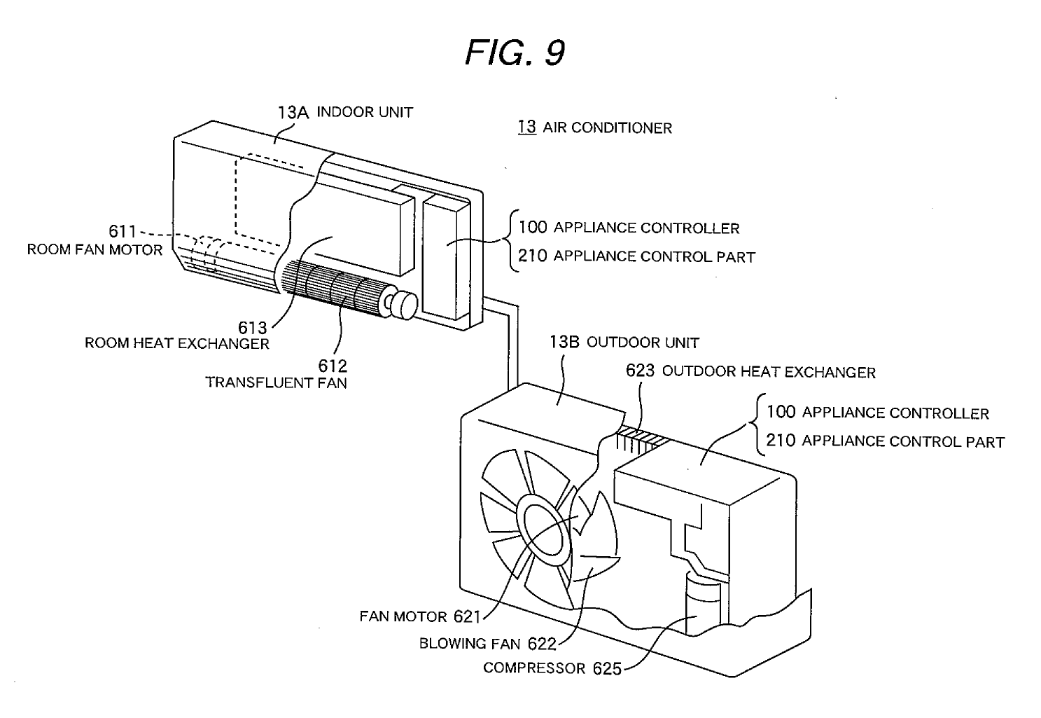

The household electric appliances 10 include various types of electric products used in the user's homes 1 and places of travel. Each household electric appliance 10 has substantially the same structure as conventional electric apparatus except that it has an incorporated appliance controller 100. Exemplary household electric appliances 10 include a washer dryer 11, which will be described later with reference to FIG. 7, a refrigerator 12, which will be described later with reference to FIG. 8, an air-conditioner 13, which will be described later with reference to FIG. 9, an electric washing machine, a clothes dryer, a microwave oven, and an electric vacuum cleaner. These are only several examples; any household electric appliances including a microprocessor used for control can be configured as the household electric appliance 10 by incorporating the appliance controller 100, regardless of their types and forms.

The appliance controller 100 has a function that, upon receipt of a prescribed radio signal, controls the household electric appliance 10 so that the operation of the household electric appliance 10 is restricted. The restricted operation may be such that the entire operation of the household electric appliance 10 is stopped, part of the operation is stopped, part of an operation mode is disabled, or the household electric appliance 10 is restored or shifted to a prescribed state. The operation is preferably restricted in such a way that risk to the body or property of the user is lessened. The appliance controller 100 holds information for identifying the household electric appliance 10 (this information will be referred to below as unit information).

The household electric appliance 10 and appliance controller 100 will be described later in detail.

Next, an overview as to how the appliance control system 1000 is operated will be given.

In the appliance control system 1000, the manufacturer operates the commanding server 30, references the unit ledger, and specifies what household electric appliance 10 is to be restricted in operation and how the operation is restricted. The commanding server 30 then creates a message including the unit information of the specified household electric appliance 10 and information about operation restrictions to be imposed (referred to below as operation restriction information) and sends the message to the relay server 20. The relay server 20 controls the mobile telephone base stations 22 via the switched network 21 to have them send a signal indicating the message (referred to below as the forcible control signal) by wireless.

In each household electric appliance 10 in the communication ranges (cells) of these mobile telephone base stations 22, the appliance controller 100 receives a forcible control signal from the mobile telephone base station 22, demodulates the received signal, and extracts the unit information. The appliance controller 100 then determines whether the unit information held therein matches the received unit information. Specifically, if a match is found in, for example, the manufacturer and model, and the manufacturing number is within a specified range, the unit information is decided to match. The appliance controller 100 then extracts the operation restriction information and restricts the operation of the household electric appliance 10 according to the operation restriction information.

Next, the structure of the household electric appliance 10 will be described in detail.

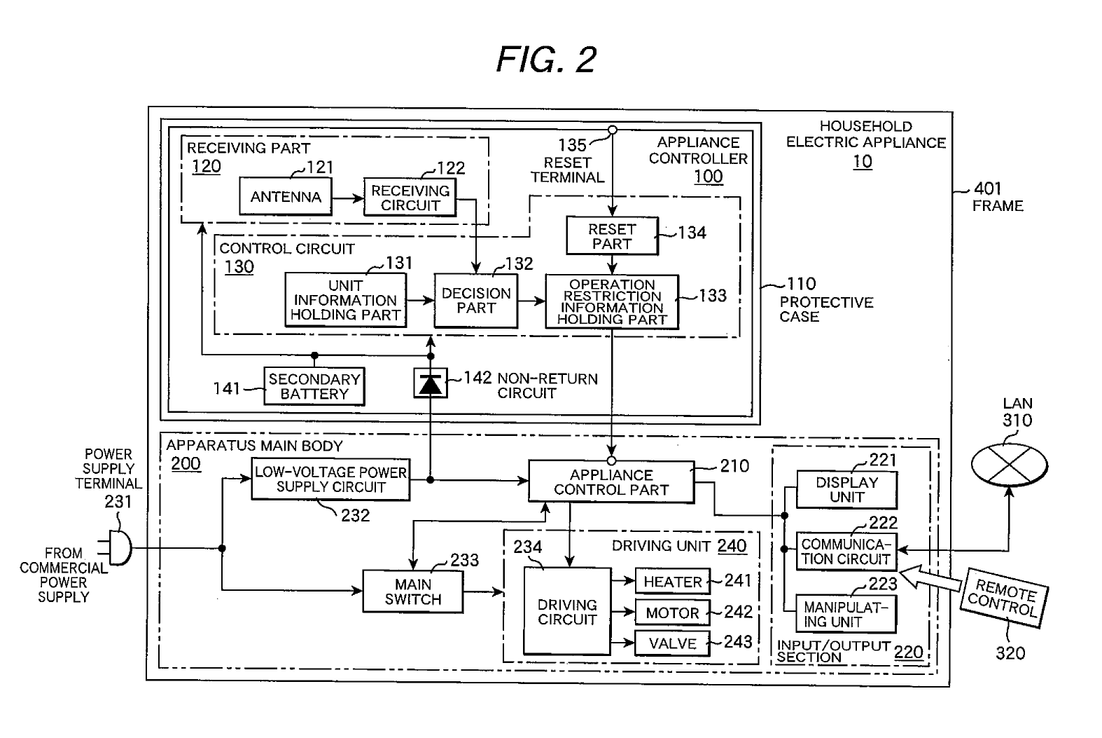

FIG. 2 is a block diagram indicating the household electric appliance 10 according to an embodiment of the present invention.

The household electric appliance 10 is structured by incorporating the appliance controller 100 in the apparatus main body 200.

The apparatus main body 200 has the same structure as a microprocessor-controlled electric appliance that is commercially available to ordinary households. That is, if a process for incorporating the appliance controller 100 is added to the processes for manufacturing ordinary household electric appliances, the household electric appliance 10 according to this embodiment can be manufactured. Even after the user has started to use an electric appliance, the household electric appliance 10 according to this embodiment can be structured by incorporating the appliance controller 100.

As described above, the apparatus main body 200 can be any electric appliance if its main operation and functions are controlled by a microprocessor; any type and from are usually accepted. So, a typical structure will be described as an example.

The apparatus main body 200 comprises a power supply terminal 231, a low-voltage power supply circuit 232, a main switch 233, an appliance control part 210, a driving unit 240, an input/output section 220, and a frame 401, which is the external frame of the apparatus main body 200. The low-voltage power supply circuit 232, the main switch 233, the appliance control part 210, and the driving unit 240 are disposed in the frame 401; the input/output section 220 is disposed in the frame 401 or attached to the frame 401.

The power supply terminal 231 is a so-called power plug; when it is connected to a wall socket (its power terminal is not shown) provided in the home, power is supplied from the commercial power supply to the household electric appliance 10 through a line laid in the home or a power line.

The low-voltage power supply circuit 232 is a DC stabilizing power supply circuit; it drops, rectifies, and smoothes the voltage of the commercial power supply, which is supplied through the power supply terminal 231, to generate a prescribed low DC voltage. The low voltage is supplied to the appliance controller 100 and appliance control part 210. The low-voltage power supply circuit 232 is connected to the power supply terminal 231 without intervention of other elements (not shown); when the power supply terminal 231 is connected to an external power supply terminal, therefore, the low-voltage power supply circuit 232 supplies operation power to the appliance controller 100 and appliance control part 210, regardless of the state of the main switch 233. Alternatively, as seen in many washing machines (not shown), commercial power may be supplied to the low-voltage power supply circuit 232 or shut off by operating a power switch (not shown) provided on a manipulating unit 223 of the input/output section 220.

The appliance control part 210 has a computer (referred to below as the control computer) for controlling various parts of the apparatus main body 200. Typically, the appliance control part 210 is a microprocessor implemented by forming a CPU, ROM, RAM, I/O part, and other elements on a semiconductor chip (these elements are not shown), which are interconnected via a bus; a control program for controlling the household electric appliance 10 and control data are stored in the appliance control part 210. When power supply from the low-voltage power supply circuit 232 is initiated, the appliance control part 210 starts. When the operation of the appliance control part 210 is started in this way or by operating the manipulating unit 223 in the input/output section 220 or a remote control 320, the appliance control part 210 reads operation restriction information from a operation restriction information holding part 133 (described below) through a terminal connected to the appliance controller 100, and controls the main switch 233 and driving unit 240 according to the operation restriction information that has been read. This control will be described below in detail.

The input/output section 220 is an interface function that inputs and outputs information to and from the appliance control part 210. Particularly, it functions as a human-machine interface. The input/output section 220 includes a display unit 221, a communication circuit 222, and the manipulating unit 223.

The display unit 221 includes a liquid crystal display, LED lamps, and an output element such as a buzzer (these elements are not shown); it has a function for having persons recognize the state of control by the appliance control part 210.

The manipulating unit 223 includes input elements (not shown) such as switches and buttons; when manually operated, it transfers the operation to the appliance control part 210.

The communication circuit 222 comprises a network interface unit, an infrared communication unit, a wireless communication unit, and the like; the communication circuit 222 intervenes transmission of control information through a LAN 310 between the appliance control part 210 and a controller (not shown) connected to the LAN 310. The communication circuit 222 also demodulates control signals transferred as infrared signals or radio signals, generates control information, and transfers the control information to the appliance control part 210.

The remote control 320 is manually operated by the user to remotely operate the household electric appliance 10. When manually operated by the user, the remote control 320 sends a control signal, which is an infrared signal or radio signal, according to how the remote control 320 is manually operated.

An operation mode and operation temperature can be set for the household electric appliance 10 by operating the manipulating unit 223 of the input/output section 220 or the remote control 320 or through the LAN 310. These settings are made as follows: when the manipulating unit 223 or remote control 320 is operated or an operation is performed through the LAN 310, an operation mode or setting is selected and determined while the display on the display unit 221, remote control 320, or LAN 310 is being viewed, information obtained from the display, that is, an operation mode, temperature, time, or another setting is fetched and held in the appliance control part 210. When an operation start command is input by operating the manipulating unit 223 or the remote control 320 or through the LAN 310 in the same way, the household electric appliance 10 is operated according to a control mode and other settings stored in advance. If the household electric appliance 10 is a refrigerator 12 (described later with reference to FIG. 8), when commercial power is supplied from the power supply terminal 231, an operation starts according to the held operation mode and temperature setting.

One end of the main switch 233 is connected to the power supply terminal 231 and the other end is connected to the driving unit 240. When there is no operation restriction, the main switch 233 is controlled by the appliance control part 210 according to a manual operation at the manipulating unit 223 of the input/output section 220, and turned on or off. When the main switch 233 is turned on, it is brought into conduction; when turned off, it is shut off. Accordingly, when the main switch 233 is turned on, power is supplied to the driving unit 240; when the main switch 233 is turned off, power is not supplied to the driving unit 240.

A manual switch (not shown) may be further provided between the power supply terminal 231 and the main switch 233 and low-voltage power supply circuit 232. For the air-conditioner 13 (described later with reference to FIG. 9) and the washer dryer 11 (described later with reference to FIG. 7), when the manual switch is turned on, the appliance control part 210 is started. The state (on or off) of the main switch 233 is stored in the appliance control part 210. While the control signal from the appliance control part 210 is turned off, the main switch 233 is kept off even when the manual switch is turned on and then the input/output section 220 is operated.

The driving unit 240 is a central element for taking advantages of the functions of the household electric appliance 10; the driving unit 240 has a heater 241, a motor 242, and a valve 243 as driving elements, and includes a driving circuit 234 for supplying power to the driving elements and driving them. It should be understood that, in the description below, the driving unit 240 has the heater 241, motor 242, and valve 243 as driving elements for illustrative purposes only; in practice, the types and the number of driving elements are determined according to the specific items and design of the household electric appliance 10. The driving circuit 234 supplies appropriate power to the heater 241, motor 242, and valve 243; for the heater 241, the driving circuit 234 controls a current value or a duty ratio used to control the current value so that prescribed temperature control is performed; for the motor 242, the driving circuit 234 controls a driving current, such as, for example, a stator current when the motor 242 is a synchronous motor; for the valve 243, the driving circuit 234 controls a current value for opening and closing the valve 243. The driving circuit 234 is controlled according to a command from the appliance control part 210, thereby controlling the heater 241, motor 242, and valve 243.

The appliance controller 100 supplies operation restriction information to the appliance control part 210 in the apparatus main body 200, according to unit information and operation restriction information included in a forcible reception signal originated from the mobile telephone base station 22 (see FIG. 1), determining operation restrictions to be imposed on the apparatus main body 200.

The appliance controller 100 has a protective case 110 disposed in the frame 401. Provided in the protective case 110 are a receiving part 120 for receiving a forcibly stopping signal that is sent by wireless and demodulating it, a control circuit 130 for supplying operation restriction information to the appliance control part 210 in the apparatus main body 200, a non-return circuit 142 inserted into a power supply line routed from the low-voltage power supply circuit 232 in the apparatus main body 200 to the receiving part 120 and control circuit 130 in the appliance controller 100, and a secondary battery 141 connected to the power supply line.

The receiving part 120 has an antenna 121 and a receiving circuit 122.

The antenna 121 receives a radio signal from the mobile telephone base station 22 and outputs a high-frequency signal to the receiving circuit 122. When the household electric appliance 10 is installed, the antenna 121 is preferably disposed so that it has a directivity in the horizontal direction. The antenna 121 may be disposed outside the protective case 110 depending on the material of the protective case 110, or outside the frame 401 depending on the material of the frame 401 of the household electric appliance 10.

The receiving circuit 122 demodulates the high-frequency signal from the antenna 121 and outputs the demodulated data to the control circuit 130. In the case in which a forcible control signal is issued from the mobile telephone base station 22, the receiving circuit 122 has the same structure as the receiving block (not shown) of a wireless mobile telephone associated with the mobile telephone base station 22. In the case in which the forcible control signal is issued from a broadcast station, the receiving circuit 122 has the same structure as the demodulation circuit in a receiving facility for receiving radio signals from the broadcast station.

The control circuit 130 has a unit information holding part 131, a decision part 132, an operation restriction information holding part 133, and a reset part 134. The control circuit 130 may be implemented by, for example, a one-chip microprocessor (not shown) in which a CPU, a ROM, a RAM, and an I/O part (not shown) are interconnected by a bus, and necessary data and programs are stored. The decision part 132 and reset part 134 may be implemented by independent hardware. The CPU may be implemented as part of functions that execute the programs.

The unit information holding part 131 stores unit information for identifying the household electric appliance 10. Specifically, the unit information holding part 131 may be structured so that this information is stored in a ROM, an EPROM, an EEPROM or another non-volatile memory. Alternatively, the unit information holding part 131 may be a memory chip having the same structure as the above memory.

The unit information can identify an individual household electric appliance 10 or a plurality of household electric appliances 10 that satisfy prescribed requirements. For example, the unit information may directly represent the following information or information associated with the following information.

(1) Manufacturer identifier: Information assigned to the manufacturer of a household electric appliance 10 and the manufacturing place 3 (see FIG. 1) managed by the manufacturer. The manufacturer can be identified by referencing the manufacturer identifier.

(2) Model number: A number assigned to the model or type of a household electric appliance 10. The model number may be any number if it is unique to the manufacturer identifier. A combination of the manufacturer code and model number identifies the model or type of the household electric appliance 10.

(3) Manufacturing number: A number uniquely assigned to each of household electric appliances 10 in the same model or type. Typically, consecutive serial numbers are assigned to household electric appliances 10 of the same model in the order of manufacturing.

The manufacturer of the household electric appliance 10 (specifically, the person who manufactured the appliance controller 100 or the person who incorporated the appliance controller 100 into the household electric appliance 10) prepares a unit ledger into which the unit information held in the unit information holding part 131 is electromagnetically recorded. The unit ledger is held in the commanding server 30 (see FIG. 1) until the manufactured household electric appliance 10 is discarded or can be no longer used. In addition to the unit information, the unit ledger preferably includes household electric appliance 10 specific information by which the location and usage status of the household electric appliance 10 can be estimated, such as, for example, the manufacturing place 3, a manufacturing line, a manufacturing date, a shipping destination (exporting destination), a delivery date, a delivery destination, a delivery date, an owner, a user, a location (area of use), a starting date of use, an ending date of use, a discarded-by person, and a date of discard. The unit ledger is also preferably updated each time new information is obtained.

The decision part 132 has the following functions; specifically these functions are implemented when the CPU executes the control program.

(1) The unit information and operation restriction information are extracted from the data demodulated by the receiving circuit 122. The unit information received by the receiving circuit 122 represents a particular group of one or a plurality of household electric appliances 10 that satisfy a prescribed condition. This particular group may be determined in advance during household electric appliance 10 manufacturing, or determined as necessary after the household electric appliances 10 have been manufactured and sold.

(2) The unit information is read from the unit information holding part 131. The unit information to be held in the unit information holding part 131 is preferably detailed as much as possible so as to increase the degree of freedom in the setting of the particular group.

(3) The unit information in (2) is compared with the unit information in (1); it is determined whether the unit information (2) matches the unit information (1), that is, whether a match is found in the group of the household electric appliances 10 represented by the received information about the particular group.

(4) If a match is found in (3), the operation restriction information received in (1) or information based on the received information is written to the operation restriction information holding part 133, the information held in the operation restriction information holding part 133 being updated and the update being held. During the holding operation, the information already held may be reset or deleted.

The operation restriction information holding part 133 is a storage part for holding operation restriction information used to determine a control state of the appliance control part 210 in the apparatus main body 200; specifically, the operation restriction information holding part 133 is implemented by a rewritable storage element such as a RAM or an EEPROM.

The operation restriction information includes (1) a power supply flag, (2) driving flags, and (3) a remedy version. The driving flags are generic names of (2a) a heater flag, (2b) a motor flag, (3c) a valve flag, and other flags corresponding to driving elements. Permission information, which determines whether operation is permitted according to the presence or absence of restriction information, may be used instead of the restriction information. When there is no restriction information, operation is permitted.

In the description that follows, driving flags include one flag corresponding to the heater 241, one flag corresponding to the motor 242, and one flag corresponding to the valve 243, but the types and number of driving flags are preferably set according to the types and number of driving elements that are included in the driving unit 240 and the operation of which should be capable of being restricted by forcible control signals. If there are three valves 243 that should be controlled independently, the driving flags may have an area for three valve flags; if a magnetron (not shown) is included as a driving element, the driving flags may include a magnetron flag.

The power supply flag and the driving flags each have two states, “permitted” and “not permitted”. The power supply flag in the “permitted” state indicates that the main switch 233 may turn on the power supply. In this case, it is of course also possible to turn off the power supply. The power supply flag in the “not permitted” state indicates that the main switch 233 must not turn on the power supply. In this case, the turned-off power supply must not be turned on; when the power supply is already turned on, it is preferably controlled so that it is turned off.

Similarly, the heater flag in the “permitted” state indicates that the heater 241 may be driven. In this case, it is of course also possible not to drive the heater 241. The heater flag in the “not permitted” state indicates that the heater 241 must not be driven. In this case, the heater 241 cannot be driven. When the heater 241 is already driven, it is preferably controlled so that the driving is stopped. The motor flag and valve flag also function in the same way. For the valve flag, “driven” and “to drive” should be read as referring to “closed” (or “opened”) and “to open” (or “to close”).

The appliance control part 210 in the apparatus main body 200 reads the operation restriction information from the operation restriction information holding part 133, and then, as described above, controls the main switch 233 according to the state of the power supply flag and controls the driving elements (the heater 241, motor 242, and valve 243) in the driving unit 240 according to the states of the driving flags. The appliance control part 210 performs control according to the operation restriction information read from the operation restriction information holding part 133 by taking priority over normal control to operate the household electric appliance 10.

When the appliance control part 210 reads the operation restriction information from the operation restriction information holding part 133, the “permitted” state of each flag described above is represented by, for example, an electric potential with a value of +1; the “not permitted” state is represented by another value (typically a potential with a value of ±0). According to this type of arrangement, when the control input terminal of the appliance control part 210 is opened, the potential becomes unpredictable, so the appliance control part 210 determines that the power supply flag and all the driving flags are placed in the “not permitted” state. The appliance control part 210 then controls the main switch 233 and turns off the power supply so as to restrict the driving of all the driving elements in the driving unit 240. This prevents the apparatus main body 200 from operating separately when the appliance controller 100 is removed by a fraudulent means or the like.

As described above, the flags are used as permission information in control by the appliance control part 210. When the appliance control part 210 is manufactured and sold, operation permission information about a household electric appliance or the arrangement of the main driving elements, that is, the operation permission information, as described above, about the motor 242, heater 241, and valves 243, or the operation permission information (not described above) equivalent to operation modes are held. When the permission information is externally deleted or modified as described above, the appliance control part 210 performs only permitted control, that is, stops the operations of non-permitted parts or functions, completely or partially stopping the operation of the household electric appliance.

The secondary battery 141 is specifically a rechargeable constant-voltage power supply backup battery, but it may comprise a charging circuit (not shown) and a rechargeable constant-current battery. While receiving power from the low-voltage power supply circuit 232 in the apparatus main body 200, the secondary battery 141 undergoes float charging; the secondary battery 141 is always fully charged. The capacity of the secondary battery 141 is determined, taken into consideration the current draw of the receiving part 120 and control circuit 130, usage of the household electric appliance 10, and other conditions. If, for example, the receiving circuit 122 is structured so that it receives signals intermittently, the power consumption is lessened and thus the capacity of the secondary battery 141 can be reduced. If the household electric appliance 10 is used in such a way that the power supply terminal 231 and an external power supply terminal are interconnected in a short time, the secondary battery 141 with a large storage capacity may be used so that the remaining capacity does not run short during a non-connection period.

The non-return circuit 142 includes, for example, a diode to allow current to flow from the apparatus main body 200 to the appliance controller 100, and also has a function for preventing current from flowing from the appliance controller 100 back to the apparatus main body 200. While power supply from the low-voltage power supply circuit 232 is stopped, therefore, current leak from the secondary battery 141 to the apparatus main body 200 is prevented, prolonging the service life of the secondary battery 141 and preventing unpredicted operation of the appliance controller 100. While power is supplied from the low-voltage power supply circuit 232, power is supplied from the apparatus main body 200 to various parts in the appliance controller 100.

The protective case 110, which is disposed in the frame 401, is a hard-to-open strong case that accommodates the parts of the appliance controller 100. The protective case 110 is preferably made of a material that allows radio signals to pass easily so that the antenna 121 can receive the radio signals easily. When the material and structure of the case of the household electric appliance 10 are such that the case is hard to open, the appliance controller 100 may be placed on the same board as the appliance control part 210 and other parts on the apparatus main body 200 side. In this case as well, at least the reset part 134 and operation restriction information holding part 133 are preferably accommodated in the protective case 110.

Furthermore, the protective case 110 has a self-destructive function for disabling the function of at least the operation restriction information holding part 133 when the protective case 110 is opened by a fraudulent means (in brief, forcibly). Accordingly, as in the case where the appliance controller 100 is removed by the above-mentioned fraudulent means or the like, the apparatus main body 200 is prevented from being operated separately.

Alternatively, the information held in the operation restriction information holding part 133 may be handled as operation permission information; the household electric appliance 10 may be operated only when the appliance control part 210 confirms operation permission. With this arrangement, if the protective case 110 is removed invalidly or the internal circuit or recorded information is modified invalidly, the information held in the operation restriction information holding part 133 is deleted or modified, preventing the household electric appliance from being operated. Accordingly, the household electric appliance is protected against unauthorized action. If the appliance controller 100 fails and cannot operate, the household electric appliance cannot be operated because the operation permission cannot be confirmed.

If the household electric appliance becomes inoperable, it is hard to determine whether there is unauthorized action. The operation of the household electric appliance may have been already prohibited by an external forcible control signal. However, it is desirable from the viewpoint of risk prevention that operation be not permitted; the arrangement described above improves safety.

The reset part 134 is an authentication function for imposing a prescribed restriction on access from a reset terminal 135. The reset part 134 verifies access from the reset terminal 135. If the access is valid, the reset part 134 permits the operation restriction information holding part 133 to be accessed and the operation restriction information held therein to be rewritten; if the access is invalid, the reset part 134 denies it.

For example, suppose that identical authentication keys are held in the reset part 134 and a service terminal (not shown) possessed by a serviceman normally delivered by the manufacturer. Upon the completion of prescribed inspection and repair, the serviceman connects the service terminal to the reset terminal 135 and attempts to access the operation restriction information holding part 133. The reset part 134 compares the authentication key sent from the service terminal with the held authentication key to verify the access. As a result of the verification, if the reset part 134 determines that the access is valid, the reset part 134 permits the access from the service terminal to the operation restriction information holding part 133, allowing the serviceman to operate the service terminal and reset the operation restriction information. The remedy version in the operation restriction information may not be reset to prevent operation from being restricted again by an identical forcible control signal.

Since the appliance controller 100 is accommodated in the protective case 110 as described above, the appliance controller 100 is structured so that the operation restriction information holding part 133 can be reset by valid access from the reset terminal 135 but cannot be reset by radio signal transmission or another method. Accordingly, once an operation restriction is imposed, the household electric appliance 10 cannot perform usual operation until it receives normal after-sales service, so the user is promoted to receive the after-sales service.

As another arrangement, the operation restriction information held in the operation restriction information holding part 133 may be reset when the power supply flag and driving flags in the operation restriction information included in a forcible control signal are all in the “permitted” state.

Next, the structure of a household electric appliance 10B, which is a variation according to the present invention, will be described in detail. In the appliance control system 1000 (see FIG. 1), the household electric appliance 10B can be used in the same way as the household electric appliance 10.

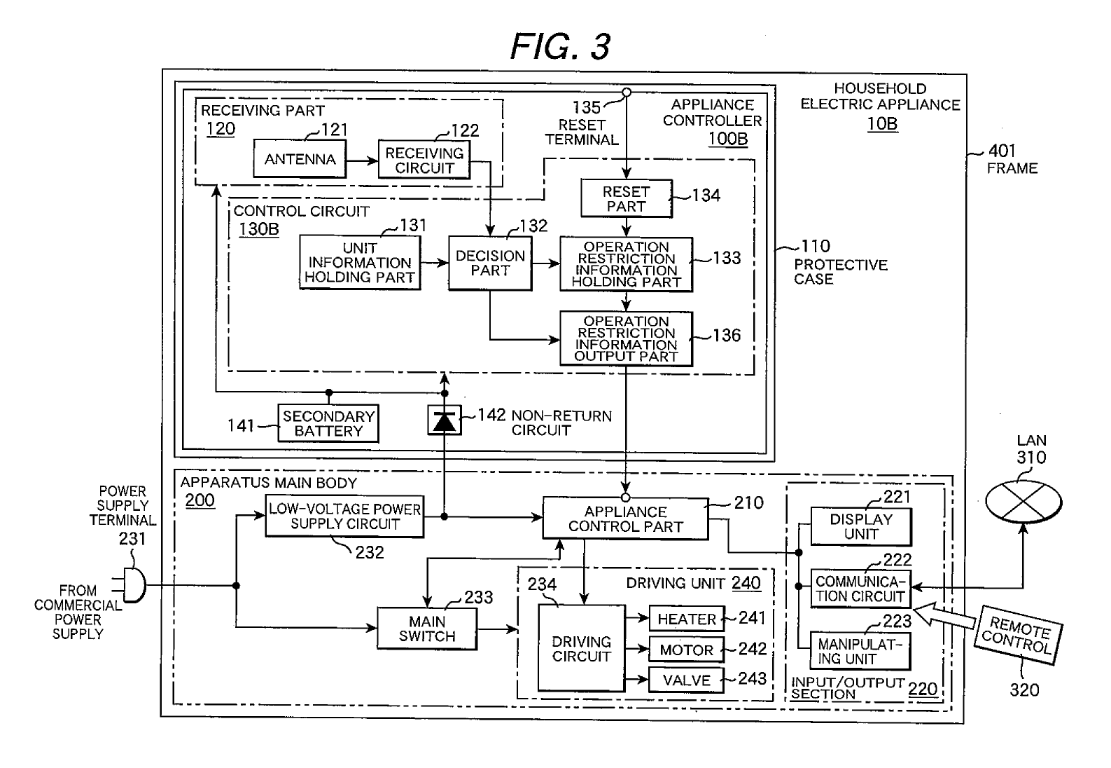

FIG. 3 shows a block diagram indicating a household electric appliance 10B, which is a variation according to the present invention. The same elements as in the household electric appliance 10 (see FIG. 2) are assigned the same reference numerals; in principle, they operate in the same way, so their description will be omitted.

The household electric appliance 10B has substantially the same structure as the household electric appliance 10 except that it has an appliance controller 100B instead of the appliance controller 100. The appliance controller 100B also has substantially the same structure as the appliance controller 100 except that it further has an operation restriction information output part 136.

The operation restriction information output part 136 reads the operation restriction information from the operation restriction information holding part 133 and outputs it to the appliance control part 210 in the apparatus main body 200, under control by the decision part 132. The output format of the operation restriction information matches the input format of the appliance control part 210, and can be determined according to the signal line condition, discrimination between parallel and serial data transfer, and other conditions.

Since the operation restriction information output part 136 is provided, the communication load of the appliance control part 210 can be reduced and a more general microprocessor can be used in the appliance control part 210.

Next, how the appliance controller 100 receives a forcible control signal and rewrites the operation restriction information holding part 133 (see FIGS. 2 and 3) will be described (this operation is called the operation restriction information update processing).

As shown in FIG. 1, suppose that the commanding server 30 sends a message to the relay server 20 in the telecommunication facility 2, and forcible control signals are originated from the mobile telephone base stations 22 under control by the relay server 20.

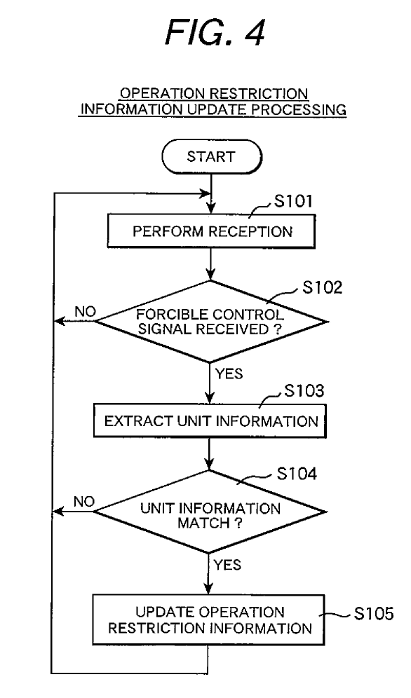

FIG. 4 shows a flowchart indicating a first example of the operation restriction information update processing (see FIGS. 2 and 3 at appropriate points).

The receiving part 120 performs a reception operation (step S101). Specifically, the antenna 121 receives a radio signal and creates a reception signal; the receiving circuit 122 demodulates the reception signal and sends the resulting data to the decision part 132.

The decision part 132 decides whether a forcible control signal has been received (step S102). Whether the forcible control signal has been received can be determined according to the data obtained by the receiving circuit 122.

If the forcible control signal has not been received (No at step S102), the sequence returns to step S101 and repeats the subsequent processing.

If the forcible control signal has been received (Yes at step S102), the decision part 132 extracts unit information from the forcible control signal (step S103).

The decision part 132 then determines whether the unit information matches (step S104). Specifically, the decision part 132 reads the unit information from the unit information holding part 131 and determines whether the read unit information matches the unit information extracted from the forcible control signal, that is, whether the unit ID (unit information) of the user, which is held in the unit information holding part 131, is included in the particular group obtained from the received information.

If no match is found (No at step S104), the sequence returns to step S101 and repeats the subsequent processing.

If a match is found (Yes at step S104), the decision part 132 updates the operation restriction information (step S105). Specifically, the decision part 132 extracts the operation restriction information from the data obtained by the receiving circuit 122 and writes the extracted operation restriction information to the operation restriction information holding part 133; the operation restriction information held in the operation restriction information holding part 133 is updated and the update is held.

Processing after step S101 is then repeated.

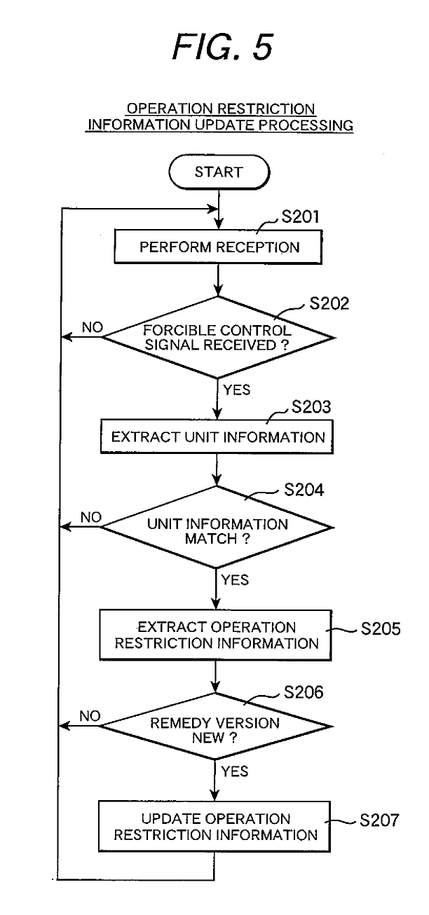

FIG. 5 shows a flowchart indicating a second example of the operation restriction information update processing (see FIGS. 2 and 3 at appropriate points). In the second example of the operation restriction information update processing, if the remedy version is not new, the operation restriction information is not updated.

Steps S201 to S204 are the same as steps S101 to S104, respectively (see FIG. 4), so their description will be omitted.

The decision part 132 determines whether the unit information matches as in step S104 (see FIG. 4) (step S204).

If no match is found (No at step S204), the sequence returns to step S201 and repeats the subsequent processing.

If a match is found (Yes at step S204), the decision part 132 extracts the operation restriction information (step S205). Specifically, the decision part 132 extracts the operation restriction information from the data obtained by the receiving circuit 122.

The decision part 132 then determines whether the remedy version is new (step S206). Specifically, the decision part 132 reads the remedy version included in the extracted operation restriction information (that is, the remedy version sent by a new forcible control signal), and also reads the remedy version included in the operation restriction information held in the operation restriction information holding part 133. The decision part 132 compares the two remedy versions; if the remedy version sent by the new forcible control signal is newer, the remedy version is decided as being new; if the remedy version sent by the new forcible control signal is older or the same, the remedy version is decided as not being new.

If the remedy version is not new (No at step S206), the sequence returns to step S201 and repeats the subsequent processing.

If the remedy version is new (Yes at step S206), the decision part 132 updates the operation restriction information (step S207). Specifically, the decision part 132 writes the operation restriction information extracted at step S205 to the operation restriction information holding part 133; the operation restriction information held in the operation restriction information holding part 133 is updated and the update is held.

Processing after step S201 is then repeated.

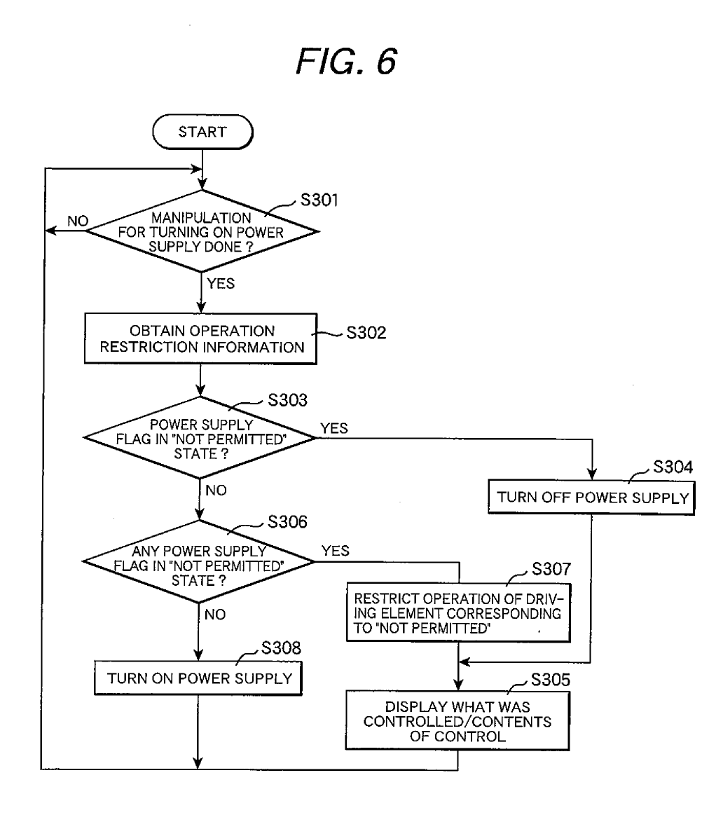

FIG. 6 shows a flowchart indicating the operation restriction processing (see FIGS. 2 and 3 at appropriate points).

First, the appliance control part 210 determines whether the main switch 233 has been operated to turn on the power supply (step S301).

If an operation to turn on the power supply has not been performed (No at step S301), the sequence returns to step S301.

If an operation to turn on the power supply has been performed (Yes at step S301), the appliance control part 210 obtains operation restriction information (step S302). Specifically, for the household electric appliance 10 (see FIG. 2), the appliance control part 210 reads operation restriction information from the operation restriction information holding part 133; for the household electric appliance 10B (see FIG. 3), the appliance control part 210 receives operation restriction information from the operation restriction information output part 136.

The appliance control part 210 then determines whether the power flag is in the “not permitted” state (step S303).

If the power flag is in the “not permitted” state (Yes at step S303), the appliance control part 210 controls the main switch 233 and turns off the power supply (step S304).

The display unit 221 displays what has been controlled/contents of control at step S304 (step S305). Specifically, the fact that control has been performed by an external signal and the fact that the power supply has been forcibly turned off are displayed.

The sequence then returns to step S301 and repeats the subsequent processing.

If the power flag is not in the “not permitted” state (No at step S303), that is, in the “permitted” state, the appliance control part 210 determines whether there are driving flags in the “not permitted” state (step S306).

If there are one or more driving flags in the “not permitted” state (Yes at step S306), the appliance control part 210 controls the driving circuit 234 and restricts the operations of the driving flags in the “not permitted” state (step S307). For example, if the heater flag is in the “not permitted” state, power supply to the heater 241 is stopped; if the motor flag is in the “not permitted” state, the driving of the motor 242 is stopped; if a valve flag is in the “not permitted” state, the valve 243 is closed (or opened).

The display unit 221 displays what has been controlled/contents of control at step S307 (step S305). Specifically, the fact that control has been performed responsive to an external signal and the driving elements the operations of which have been restricted are displayed.

The sequence then returns to step S301 and repeats the subsequent processing.

If none of the driving flags is “not permitted” state (No at step S306), that is, all the driving flags are in the “permitted” state, the operation of the main switch 233 is not restricted; the power supply is turned on by the main switch 233.

The sequence returns to step S301 and repeats the subsequent processing.

The procedure by which operation is restricted when the main switch 233 is operated has been described; even while a driving element is operating in the driving unit 240, however, its operation may be restricted at appropriate times according to the operation restriction information.

Furthermore, as a simplified variation, if it is determined that an appliance identified by the information held in the unit information holding part is included in a group identified by unit information sent, information indicating the inclusion may be simply held in the operation restriction information holding part and appliance operation may not be permitted according to the information. In this case, operation is disabled. In this type of method, hardware and software are very simple, increasing the reliability of operation.

FIG. 7 shows the longitudinal cross section of the washer dryer 11, which is one type of the household electric appliance 10.

In principle, the washer dryer 11 has the same structure as ordinary washer dryers, except that it has the appliance controller 100.

The washer dryer 11 has a frame 401 internally including a outer tank 405, a motor 242 for driving a washing/dewatering basket 402 disposed in the outer tank 405. A heater (PTC heater), a water cooling, a dehumidification duct 423 with a suction port 405a and a cooling water spraying part 424 connected to the outer tank 405, a downward air truck duct 425, and an upward air truck duct 427 with a expelling port 430 are provided inside of the frame 401. The washer dryer 11 is provided with a drain hose 434 connected to the outer tank 405, a detergent dissolving case 421, a filling port 419 for water, and a water plug connection port 418 with valve 243 or a main water supply solenoid 420 or an auxiliary water supply solenoid 422, 422a. So, laundry 438 in the washing/dewatering basket 402 is washed and dried by the washer dryer 11.

During normal washing or rinsing, an exhaust valve 433 is closed, a main water supply solenoid 420, and auxiliary water supply solenoids 422 and 422a are opened, and washing water or rising water flows out of an expelling port 430 through a water plug connection port 418. When water is stored in an outer tank 405, the motor 242 rotates a washing/dewatering basket 402, performing washing and rinsing.

The basic operation has been described with reference to FIG. 2 or 3. When an operation mode is selected on the manipulating unit 223 (see FIG. 2 or 3) attached to the frame 401, the appliance controller checks the information in the operation restriction information holding part 133 according to the manipulation performed on the manipulating unit 223 to start an operation, and operation is permitted; when the information held in the operation restriction information holding part 133 indicates no operation restriction, the appliance controller is operated in the selected operation mode; when the information indicates any restriction, the appliance controller undergoes operation restrictions including the stopping of operation, as described above.

The appliance control part 210 and appliance controller 100 are preferably disposed in the space above the washing/dewatering basket 402, toward the user (on the left in the drawing) or at the back (on the right in the drawing). In the example in the drawing, the appliance control part 210 and appliance controller 100 are disposed toward the user. In this place, adverse effects such as moisture are not brought easily and, even after prolonged use, the appliance controller 100 is less likely to fail than when disposed in another place.

FIG. 8 shows the longitudinal cross section of the refrigerator 12, which is one type of the household electric appliance 10 (see FIGS. 2 and 3 at appropriate times).

The refrigerator 12 has a frame 401 internally including a heat insulating material 510. Provided in the frame 401 are a heat exchanger 512, a radiator 514, a compressor 501 including an electric motor (not shown), a temperature sensor (not shown) for measuring the temperature in the refrigerator, a heater 241 for defrosting, an appliance control part 210 for controlling the driving of the compressor 501 and heater 241 according to the measurement of the temperature sensor, and an appliance controller 100 for holding operation restriction information to be supplied to the appliance control part 210.

The basic operation has been described with reference to FIGS. 2 and 3. When the operation restriction information held in the appliance controller 100 permits an operation, the appliance control part 210 monitors the output from the temperature sensor (not shown); if the temperature setting is exceeded, the motor (not shown) of the compressor 501, equivalent to the motor 242 (see FIG. 2 or 3) of the driving unit 240, is run so as to supply the coolant under pressure from the compressor 501 to the radiator 514 and radiates the heat of the coolant from the radiator 514. The heat-radiated coolant expands in a refrigeration cycle, lowering its temperature. The cooled coolant is passed to the heat exchanger 512. The heat exchanger 512 cools the air in the refrigerator, and the cooled air is passed to the freezer, cooling compartment, and chill compartment in the refrigerator by a motor-driven fan (not shown). A manipulating unit 223 (not shown, see FIGS. 2 and 3) provided inside the refrigerator 12 is used to set the temperatures of the cooling compartment and other compartments in the refrigerator. The appliance control part 210 controls the compressor 501, the above temperature settings being target temperatures. When an external forcible control signal is sent and the held operation restriction information is modified so that operation restrictions including the stopping of operation are imposed as described above, the appliance control part 210 performs an operation according to this modification by overriding the previous settings. When, for example, an external command to stop the operation is issued, the user manipulation is overridden and the operation is stopped.

The refrigerator 12 further has a main switch 233. A mechanism for shutting down the main power supply such as a circuit breaker may be used instead of the main switch 233.

The operation restrictions imposed on the refrigerator 12 will now be described.

When the appliance controller 100 receives a forcible control signal and the unit information included in the forcible control signal is applicable to the refrigerator 12, the operation restriction information that has been included in the forcible control signal is read by the appliance control part 210 from the appliance controller 100 and the appliance control part 210 restricts the operation as described below.

(1) If the power flag is in the “not permitted” state, the appliance control part 210 controls the main switch 233 and turns off the power supply.

(2) If the heater flag is in the “not permitted” state, the appliance control part 210 performs control so that power supply to the heater 241 is stopped.

(3) If the motor flag is in the “not permitted” state, control is performed so that the operation of the electric motor in the compressor 501 is stopped.

FIG. 9 is an external perspective view of the air-conditioner 13, which is one type of the household electric appliance 10 (see FIGS. 2 and 3 at appropriate times).

The air-conditioner 13 comprises an indoor unit 13A and an outdoor unit 13B, the heat exchange system therein being connected to the indoor unit 13A. The indoor unit 13A and outdoor unit 13B each have an appliance control part 210, an appliance controller 100 from which operation restriction information is supplied to the appliance control part 210, and a circuit breaker (not shown) for shutting down the main power supply.

In the indoor unit 13A, a coolant is supplied from the outdoor unit 13B to the room heat exchanger 613, where the air is cooled or heated. The cooled or heated air is supplied to the room by a transfluent fan 612. The transfluent fan 612 is rotated by a room fan motor 611, the driving of which is controlled by the appliance control part 210.

The operation restrictions imposed on the indoor unit 13A will now be described.

When the appliance controller 100 receives a forcible control signal and the unit information included in the forcible control signal is applicable to the indoor unit 13A, the operation restriction information that has been included in the forcible control signal is read by the appliance control part 210 from the appliance controller 100 and the appliance control part 210 restricts the operation as described below. Alternatively, the operation permission information, which is held at the time of manufacturing and delivered, is deleted or modified according to the forcible control signal received as described above.

(1) If the power flag is in the “not permitted” state, the appliance control part 210 controls the circuit breaker and turns off the power supply.

(2) If the motor flag is in the “not permitted” state, control is performed so that the operation of the room fan motor 611 is stopped.

In the outdoor unit 13B during cooling, the coolant in the outdoor heat exchanger 623 is compressed by the compressor 625 and exhausts heat. During heating, the coolant compressed by the compressor 625 in the room heat exchanger 613 is expanded in the outdoor heat exchanger 623 and its heat is absorbed by the coolant. The driving of the compressor 625 is controlled by the appliance control part 210.

In the outdoor unit 13B, the coolant is supplied from the indoor unit 13A to the outside heat exchanger 623, where the air is heated or cooled. The heated or cooled air is supplied to the outside by a blowing fan 622. The blowing fan 622 is rotated by a fan motor 621, the driving of which is controlled by the appliance control part 210. The heater 241 shown in FIGS. 2 and 3 are not provided with the air-conditioner 13 shown in FIG. 9.

The operation restrictions imposed on the outdoor unit 13B will now be described.

When the appliance controller 100 receives a forcible control signal and the unit information included in the forcible control signal is applicable to the outdoor unit 13B, the operation restriction information that has been included in the forcible control signal is read by the appliance control part 210 from the appliance controller 100 and the appliance control part 210 restricts the operation as described below.

(1) If the power flag is in the “not permitted” state, the appliance control part 210 controls the circuit breaker and turns off the power supply.

(2) If the motor flag is in the “not permitted” state, control is performed so that the operation of the fan motor 621 is stopped.

According to the embodiments of the present invention, the following effects are obtained.

(1) In the construction of the transmission system in the appliance control system 1000, the telecommunication facility 2 that intervenes in communication with wireless mobile telephones, facilities in broadcasting based on the conditional access system (CAS), facilities in data broadcasting and data teletext broadcasting, and other many facilities in existing communication infrastructures can be shared. Thus, the construction is simplified, reducing costs involved in the construction as well as maintenance and management.

(2) If an incident or disaster due to other than household electric appliances 10 occurs, before its effect propagates to an area, the operations of the household electric appliances 10 in that area can be restricted, contributing to suppressing the incident or disaster from extending. For example, natural gases and other high-energy materials are used in various areas in the world, and safety countermeasures are taken for facilities handling these materials. When an accident occurs in an area, if the operations of the household electric appliances 10 in that area can be forcibly stopped, however, safety is further increased. Even when the household electric appliance 10 itself is not problematic, it is desirable that countermeasures be taken against dangerous situations such as earthquakes, although specific situations cannot be assumed.

In practice, it is not possible to continue to operate the household electric appliance 10 permanently in far excess of years that could be considered reasonable based on common sense after the household electric appliance 10 has been manufactured. Accordingly, if the household electric appliance 10 continues to be operated in far excess of years that could be considered reasonable based on common sense after the household electric appliance 10 has been manufactured, it is desirable to externally restrict its operation from the viewpoint of increasing safety, that is, to modify or delete the operation permission information. In some situations, secondhand household electric appliances 10 may be exported without permission of the manufacturer, sold in many countries and regions, and continue to be operated without normal maintenance and management. Since, to allow for this, their operations can be externally stopped as necessary, representatives in these countries and regions can reserve countermeasures for, for example, increasing safety.

(3) Since existing mobile telephone networks (cellular networks) and digital broadcasting facilities can be used as facilities for sending forcible control signals to construct a system, costs involved in the construction and maintenance of a transmission system can be reduced. A high coverage ratio for a population size enables household electric appliances 10 to be controlled with high efficiency.

(4) When a mobile telephone network (cellular network) is used as a transmission facility, whether to transmit can be determined for each cell, so versatile settings can be made for regions to be controlled.

(5) When a broadcasting network is used as a transmission facility, a large aerial wire capacity enables a large number of household electric appliances 10 to be controlled with a small number of broadcasting stations.

(6) Both the transmission and reception sides can use the principle and facilities of an existing communication system or broadcasting system, simplifying system construction.

(7) No telecommunication construction is needed for the household electric appliance 10, so specific loads are not imposed on users and dealers.

(8) The appliance controller 100 operates according to a forcible control signal, which is transmitted by wireless, so there is no need to construct a communication network or lay wires at the user's home 1.

(9) To restrict the operation of the household electric appliance 10, it suffices for the manufacturer to operate the commanding server 30. The user can use the household electric appliance 10 in a usual manner and does not learn special manipulation steps.

(10) The secondary battery 141 is float charged, so with the power supply terminal 231 connected to a commercial power supply, the secondary battery 141 is almost fully charged. Accordingly, even while the power supply terminal 231 is not connected to the commercial power supply, the appliance controller 100 can operate for a long period of time until the energy charged in the secondary battery 141 is discharged; while the appliance controller 100 is operating, forcible control signals can be received.

(11) Intermittent operation of the receiving circuit 122 reduces the average power consumption of the appliance controller 100. This prolongs the operation time of the appliance controller 100 when the commercial power supply is not available.

(12) If the household electric appliance 10 is left unconnected to the commercial power supply for an extremely long period of time, the remaining capacity of the secondary battery 141 runs short and the power flag and driving flags held in the operation restriction information holding part 133 are placed in the “not permitted” state, preventing the household electric appliance 10 from operating. When this happens, the user can be promoted to inspect it. When the above charged energy is discharged to some extent, if the information, which is held in the appliance controller 100 and indicates permission, is deleted, operation is disabled. The fact that the discharging of the secondary battery 141 terminates indicates that the household electric appliance 10 has not been used for a prolonged period. It is desirable from the viewpoint of safety that a household electric appliance left unused for a prolonged period be stopped. In normal inspection of this type of household electric appliance, an authorized salesman manipulates the reset part 134 to restore the household electric appliance to the state in which an operation permission signal is held, which is preferable to the user.

(13) When the control input terminal is opened, the appliance control part 210 recognizes that the power supply flag and all the driving flags in the operation restriction information are in the “not permitted” state. This prevents the apparatus main body 200 from operating when the appliance controller 100 is removed or destructed by a fraudulent means.

The user can be promoted with ease to undergo after-service service, so a dealer can aggressively encourage users to purchase the household electric appliances 10 and 10B, and an increase in sales of electric appliances can be expected.

What is claimed is:

1. A household electric appliance having a control computer for controlling an operation thereof, comprising:
a unit information holding part to hold an unit information identifies the household electric appliance;
an operation restriction information holding part that capable of holding an operation restriction information indicating an operation restriction to be imposed on the household electric appliance;
a receiving part for receiving a forcible control signal including the unit information and the operation restriction information and being transmitted by wireless, and demodulating the unit information and the operation restriction information; and
a decision part to hold the operation restriction information demodulated by the receiving part in the operation restriction information holding part when the unit information held in the unit information holding part matches the unit information demodulated by the receiving part;
wherein the control computer restricts the operation of the household electric appliance according to the operation restriction information held in the operation restriction information holding part.

2. A household electric appliance having a control computer for controlling an operation thereof, comprising:
a unit information holding part to hold an unit information identifies the household electric appliance;
an operation restriction information holding part capable of holding an operation restriction information indicating an operation restriction to be imposed on the household electric appliance;
a receiving part for receiving a forcible control signal including the unit information and the operation restriction information and being transmitted by wireless, and demodulating the unit information and the operation restriction information;
a decision part to hold the operation restriction information demodulated by the receiving part in the operation restriction information holding part when the unit information held in the unit information holding part matches the unit information demodulated by the receiving part; and
an operation restriction information output part for outputting the operation restriction information to the control computer so as to restrict the operation of the household electric appliance is controlled according to the operation restriction information held in the operation restriction information holding part.

3. The household electric appliance according to claim 1, wherein:
the operation restriction information includes a power supply flag or a driving flag to be placed in a “permitted” state or a “not permitted” state to indicate respectively whether or not a main power supply of the household electric appliance is permitted to be turned on or whether or not any driving element in the household electric appliance is permitted to be operated; and
the control computer controls the main power supply not to be turned on when the power supply flag is in the “not permitted state”, and controls the driving element not to be operated when the driving flag is in the “not permitted” state.

4. The household electric appliance according to claim 1, wherein when the operation restriction information held in the operation restriction information holding part indicates an operation restriction to be imposed on the household electric appliance, the operation restriction information holding part holds the operation restriction information not to be updated by a signal transmitted by wireless and so as not to be removed the operation restriction.

5. The household electric appliance according to claim 1, further comprising a reset part for verifying external access to the operation restriction information holding part and allows the operation restriction information holding part to be rewritten when the external access is valid.

6. The household electric appliance according to claim 5, further comprising a protective case not to allow an appliance controller including at least the operation restriction information holding part and the reset part to be opened easily.

7. The household electric appliance according to claim 6, wherein the control computer controls the household electric appliance to stop the operation thereof when the protective case is opened.

8. The household electric appliance according to claim 1, further comprising a secondary battery that undergoes float charging while power is externally supplied to the household electric appliance, and supplies power to an appliance controller including at least the receiving part and the decision part while no power is externally supplied to the household electric appliance.

9. The household electric appliance according to claim 8, wherein the operation restriction information held in the operation restriction information holding part is rewritten to indicate the operation of the household electric appliance should be stopped when the remaining capacity of the secondary battery runs short.

10. An appliance controller incorporated into a household electric appliance having a control computer for controlling an operation thereof, comprising:
a unit information holding part to hold a unit information that identifies the household electric appliance;
an operation restriction information holding part capable of holding an operation restriction information indicating an operation restriction to be imposed on the household electric appliance;
a receiving part for receiving a forcible control signal including the unit information and the operation restriction information and being transmitted by wireless, and demodulating the unit information and the operation restriction information; and
a decision part to hold the operation restriction information demodulated by the receiving part in the operation restriction information holding part when the unit information held in the unit information holding part matches the unit information demodulated by the receiving part;
wherein the control computer restricts the operation of the household electric appliance according to the operation restriction information held in the operation restriction information holding part.

11. An appliance controller incorporated into a household electric appliance having a control computer for controlling an operation thereof, comprising:
a unit information holding part to hold an unit information that identifies the household electric appliance;
an operation restriction information holding part capable of holding an operation restriction information indicating an operation restriction to be imposed on the household electric appliance;
a receiving part for receiving a forcible control signal including the unit information and the operation restriction information and being transmitted by wireless, and demodulating the unit information and the operation restriction information;
a decision part to hold the operation restriction information demodulated by the receiving part in the operation restriction information holding part when the unit information held in the unit information holding part matches the unit information demodulated by the receiving part; and
an operation restriction information output part for outputting the operation restriction information to the control computer so as to restrict the operation of the household electric appliance is controlled according to the operation restriction information held in the operation restriction information holding part.

12. An appliance control system having a household electric appliance according to claim 1; further comprising a transmission facility capable of transmitting by wireless a forcible control signal including the unit information identifying the household electric appliance and the operation restriction information indicating an operation restriction to be imposed on the household electric appliance, and
a commanding server for transmitting the operation restriction information to the transmission facility to send the forcible control signal from the transmission facility by wireless.

13. The appliance control system according to claim 12, wherein the transmission facility includes a mobile telephone basic station in a telecommunication facility involved in telecommunication business and a transmission unit in a broadcast station for performing broadcasting by a method to control an audio-visual content provided on a reception facility in response to an identifier of the reception facility or a transmission unit in a broadcast station for performing data broadcasting or data multiplex broadcasting.

14. A household electric appliance having a device for receiving power from a commercial power supply, a low-voltage power supply circuit for converting the voltage of the supplied commercial power to a prescribed low voltage, a driving unit, an appliance controller for controlling the driving unit, low-voltage power being supplied from the low-voltage power supply circuit to the appliance controller, a manipulating unit, a display unit, and a frame, at least the low-voltage power supply circuit, the driving unit, and the appliance controller being disposed in the frame, the appliance controller displaying on the display unit an operation mode input according to a manipulation on the manipulating unit and holding an information about the operation mode input, the household electric appliance being operated under control in which the appliance controller controls the driving unit in an operation mode determined by an information about the operation mode held according to an operation start manipulation on the manipulating unit, further comprising:
a unit information holding part to hold an unit information identifies the household electric appliance;
a receiving part for receiving a radio signal including an identifying information of the household electric appliance group identifies a group of household electric appliances under a specific condition out of many manufactured household electric appliances, and demodulating the group identifying information; and
a decision part for determining whether the unit information held in the unit information holding part is applicable to the group identified by the group identifying information demodulated by the receiving part;
wherein the appliance controller does not start an operation according to an output from the decision part indicating the unit information held in the unit information holding part is applicable to the group identified by the demodulated group identifying information, regardless of the manipulation on the manipulating unit.

15. A household electric appliance having a device for receiving power from a commercial power supply, a low-voltage power supply circuit for converting the voltage of the supplied commercial power to a prescribed low voltage, a driving unit including a motor and a driving circuit for driving the motor, an appliance controller for controlling the driving circuit in the driving unit, low-voltage power being supplied from the low-voltage power supply circuit to the appliance controller, a main switch for supplying the commercial power to the driving unit or shutting down the commercial power, and an input/output section including a manipulating unit and a display unit, the appliance controller displaying on the display unit an operation mode input according to manipulation on the manipulating unit and holding information about the operation mode input, the appliance controller controlling the driving unit in an operation mode determined by an information about the operation mode held according to an operation start manipulation on the manipulating unit, further comprising:
a unit information holding part to hold a unit information that identifies the household electric appliance;
a receiving part for receiving a radio signal including an identifying information of the household electric appliance group identifies a group of household electric appliances under a specific condition out of manufactured household electric appliances, and demodulating the group identifying information; and
a decision part for determining whether the unit information held in the unit information holding part is applicable to the group identified by the group identifying information demodulated by the receiving part;
wherein the appliance controller shuts down the power supply of the commercial power from the main switch to the driving unit according to an output from the decision part indicating the unit information held in the unit information holding part is applicable to the group identified by the demodulated group identifying information, regardless of the manipulation on the manipulating unit.

16. A household electric appliance having a device for receiving power from a commercial power supply, a low-voltage power supply circuit for converting the voltage of the supplied commercial power to a prescribed low voltage, a driving unit including a motor and a driving circuit for driving the motor, an appliance controller for controlling the driving circuit in the driving unit, the appliance controller receiving low-voltage power from the low-voltage power supply circuit, and an input/output section including a display unit and a transmission/reception circuit associated with a remote control, the appliance controller holding information about an operation mode input by a reception signal from the remote control, the appliance controller controlling the driving unit in the operation mode held according to an operation start signal from the remote control, further comprising:
a unit information holding part, a receiving part, and a decision part which are included in the appliance controller, wherein:
the unit information holding part holds unit information identifies the household electric appliance;
the receiving part receives a radio signal including an identifying information of the household electric appliance group identifies a group of household electric appliances under a specific condition out of household electric appliances;
the decision part determines whether the unit information held in the unit information holding part is applicable to the group identified by the group identifying information demodulated by the receiving part; and
the appliance controller prohibits the operation of the driving unit, when the unit information held in the unit information holding part is applicable to the group identified by the group identifying information demodulated by the receiving part, regardless of the manipulation on the manipulating remote control.

17. A household electric appliance having a device for receiving power from a commercial power supply, a low-voltage power supply circuit for converting the voltage of the supplied commercial power to a prescribed low voltage, a driving unit including a motor and a driving circuit for driving the motor, an appliance controller for controlling the driving circuit in the driving unit, low-voltage power being supplied from the low-voltage power supply circuit to the appliance controller, and an input/output section including a manipulating unit, the appliance controller holding information about an operation mode input by manipulation on the manipulating unit, the appliance controller controlling the driving unit in an operation mode determined by an information about the operation mode held according to an operation start manipulation on the manipulating unit, further comprising:
a unit information holding part, a receiving part, and a decision part which are included in the appliance controller, wherein:
the unit information holding part holds unit information identifies the household electric appliance;
the receiving part receives a radio signal including an identifying information of the household electric appliance group identifies a group of household electric appliances under a specific condition out of household electric appliances and an operation restriction information indicating an operation restriction to be imposed on the household electric appliance, and demodulates the group identifying information and the operation restriction information from the received radio signal;
the decision part determines whether the unit information held in the unit information holding part is applicable to the group identified by the group identifying information demodulated by the receiving part, and holds information based on the demodulated operation restriction information when the unit information held in the unit information holding part is applicable to the group identified by the group identifying information demodulated by the receiving part; and
the appliance controller controls the driving unit according to the information held based on the operation restriction information, by taking priority over the operation mode information held or input from the manipulating unit.

18. A household electric appliance having a device for receiving power from a commercial power supply, a low-voltage power supply circuit for converting the voltage of the supplied commercial power to a prescribed low voltage, a driving unit including a motor for operating a compressor and a driving circuit for driving the motor, an appliance controller for controlling the driving unit, low-voltage power being supplied from the low-voltage power supply circuit to the appliance controller, and a manipulating unit for setting a temperature, the appliance controller controlling the driving unit according to the temperature setting, further comprising:
a unit information holding part, a receiving part, and a decision part which are included in the appliance controller, wherein:
the unit information holding part holds unit information identifies the household electric appliance;
the receiving part receives a radio signal, which includes an identifying information of the household electric appliance group identifies a group of household electric appliances under a specific condition out of household electric appliances;
the decision part determines whether the unit information held in the unit information holding part is applicable to the group identified by the group identifying information demodulated by the receiving part; and
the appliance controller stops the operation of the driving unit, when the unit information held in the unit information holding part is applicable to the group identified by the group identifying information demodulated by the receiving part, regardless of power supply from the commercial power supply.

19. A household electric appliance having a device for receiving power from a commercial power supply, a low-voltage power supply circuit for converting the voltage of the supplied commercial power to a prescribed low voltage, a driving unit including a motor for operating a compressor and a driving circuit for driving the motor, an appliance controller for controlling the driving unit, low-voltage power being supplied from the low-voltage power supply circuit to the appliance controller, and a manipulating unit for setting a temperature, the appliance controller controlling the driving unit according to the temperature setting, further comprising:
a unit information holding part, a receiving part, and a decision part which are included in the appliance controller, wherein:
the unit information holding part holds unit information identifies the household electric appliance;
the receiving part receives a radio signal including an identifying information of the household electric appliance group identifies a group of household electric appliances under a specific condition out of household electric appliances and an operation restriction information indicating an operation restriction to be imposed on the household electric appliance, and demodulates the group identifying information and the operation restriction information from the received radio signal;
the decision part determines whether the unit information held in the unit information holding part is applicable to the group identified by the group identifying information demodulated by the receiving part, and holds information based on the demodulated operation restriction information when the unit information held in the unit information holding part is applicable to the group identified by the group identifying information demodulated by the receiving part; and
the driving unit is controlled according to the information held based on the operation restriction information.

20. The household electric appliance according to claim 14, further comprising a frame, wherein:
the low-voltage power supply circuit, the driving unit and the appliance controller are disposed in the frame;
a protective case is provided in the frame, the unit information holding part, the receiving part and the decision part are disposed in the protective case; and
low-voltage power is supplied from the low-voltage power supply circuit to the unit information holding part, the receiving part and the decision part in the protective cover, respectively.

21. The household electric appliance according to claim 14, further comprising a secondary battery, wherein:
low-voltage power is supplied from the low-voltage power supply circuit to the secondary battery; and
power is supplied from the secondary battery to the unit information holding part, the receiving part, and the decision part, respectively.

22. The household electric appliance according to claim 21, wherein information is recorded when a discharge state of the secondary battery provided in the household electric appliance is in a prescribed state or better, and the operation of the household electric appliance is prohibited based on information about the discharge state of the secondary battery, regardless of commercial power supply from the device for receiving the commercial power supply and independently of manipulation on the manipulating unit.

23. A household electric appliance having a device for receiving power from a commercial power supply, a low-voltage power supply circuit for converting the voltage of the supplied commercial power to a prescribed low voltage, a driving unit including a motor and a driving circuit for driving the motor, an appliance controller for controlling the driving circuit in the driving unit, the appliance controller receiving low-voltage power from the low-voltage power supply circuit, and a manipulating unit, the appliance controller holding information about an operation mode or setting input from the manipulating unit, the appliance controller controlling the driving unit according to the held operation mode or setting, responsive to an operation start signal from the manipulating unit; further comprising:
an operation restriction information holding part, a unit information holding part, a receiving part, and a decision part which are included in the appliance controller; wherein:
the operation restriction information holding part holds permission information that permits an operation, the appliance controller checks the permission information in the operation restriction information holding part according to an operation start signal from the manipulating unit, and performs an operation according to the operation mode or the setting input from the manipulating unit when the operation permission information is held;
the unit information holding part holds unit information identifies the household electric appliance;
the receiving part receives a radio signal including an identifying information of the household electric appliance group identifies a group of household electric appliances under a specific condition out of household electric appliances;
the decision part determines whether the unit information held in the unit information holding part is applicable to the group identified by the group identifying information demodulated by the receiving part, and deletes or modifies the permission information held in the operation restriction information holding part when the unit information held in the unit information holding part is applicable to the group identified by the group identifying information demodulated by the receiving part; and
the appliance controller operates according to the deleted or modified permission information.
